(19) United States
(12) Patent Application Publication
(10) Pub. No.: US 2005/0244789 A1
(43) Pub. Date: Nov. 3, 2005

(54) Aesthetic dental implant fixture and abutment system

(76) Inventors: Constant C. Crohin, Watertown, MA (US); S. Faheem Rasool, Chestnut Hill, MA (US)

Correspondence Address: GOTTLIEB RACKMAN & REISMAN PC, 270 MADISON AVENUE, 8TH FLOOR, NEW YORK, NY, 100160601, US

(21) Appl. No.: 11/114,884

(22) Filed: Apr. 26, 2005

Related U.S. Application Data
(60) Provisional application No. 60/566,761, filed on Apr. 30, 2004.

(51) Int. Cl. A61C 8/00

(52) U.S. Cl. 433/173; 433/201.1

(57) ABSTRACT

A dental implant fixture and abutment system for use in restorative dental surgery comprises a thin coating, preferably of gold, applied to certain regions of the implant fixture and to certain regions of the abutment post, so as to mask or camouflage the unattractive dark root and crown appearance of prior art dental restorations which is caused primarily by the innate gray-black chroma of the titanium alloys out of which such restorations are conventionally fabricated. Optionally, the implant fixture may also be shaped such that, upon placement in the mouth, the transgingival portions of the implant fixture are more coronal on the palatal aspect and more apical on the facial aspect, thereby accommodating the differences in the residual alveolar ridge morphology and allowing for maintenance of peri-implant bone height post implant placement. Both one-stage and two-stage dental implant systems having such characteristics are disclosed, as are dental restoration systems in which a prosthetic tooth device or crown is combined with a one-stage or two-stage dental implant having such a characteristics.

### REFERENCE TO RELATED APPLICATIONS

This application claims the benefit of prior co-pending U.S. Provisional Patent Application Ser. No. 60/566,761, filed Apr. 30, 2004.

### TECHNICAL FIELD

The present invention relates generally to the field of dental restoration systems, and more specifically to an implant fixture and abutment system that confers an aesthetically pleasing appearance on the entire restoration.

### BACKGROUND OF THE INVENTION

Dental implants are used in place of missing and/or extracted natural teeth as the base of support for an abutment and a final prosthesis, in an attempt to restore normal oral function and appearance. First, the implant fixture or body is surgically inserted directly into the alveolar bone of a patient's jaw (mandibular or maxillary bone), and once the implant becomes fully integrated with the bone, it is ready to accept an abutment post which is attached using a variety of connection or mating engagement mechanisms of different designs. The abutment, which passes through the soft gingival tissue that covers the coronal end of the implant fixture, and which therefore provides a structure for extending the implant fixture above the gum line, acts in turn as the mounting feature for attachment of the prosthetic tooth device or crown, which ultimately functions to restore oral function and appearance. Basic techniques of implant dentistry are described in “An Illustrated Guide to Understanding Dental Implants,” by Scott D. Ganz, D.M.D. (1993, S.D.G. Publications, Fort Lee, N.J.).

The implant fixture and the abutment are typically fabricated from a bio-compatible material such as titanium, which is of sufficient strength to withstand the forces normally associated with mastication, and which at the same time allows a high degree of osseointegration. The benefits of using titanium are well known in the art and are described in U.S. Pat. No. 5,573,401 to Davidson et al., entitled “Biocompatible, Low Modulus Dental Devices.” This patent discloses dental devices (including implants, abutments, bridges, screws, and orthodontic appliances) that are fabricated from low modulus, bio-compatible, non-toxic Ti—Nb—Zr alloys; indeed, the latter have now become the standard material used to manufacture endosseous implants, since they provide an interface that results in significant attachment between implant and bone.

Although the success rate of such implants has been greatly improved in recent years as a result of the use of this material, the increased reliance on such implants especially to replace teeth in the anterior, aesthetically demanding regions of the mouth has increased the challenge to produce a bio-mimetic result. Unfortunately, the innate chroma of titanium is in the gray-black spectrum which, due to the translucency of the peri-implant structures that surround the implant fixture and abutment, is visible through the prosthesis, and results in the common clinical observation that implants and abutments fabricated of this material yield an unattractive dark root and crown appearance. Accordingly, while the properties of titanium are certainly beneficial in the bone region, this material produces an unacceptable appearance in transgingival region (the upper zone of the implant which is in contact with the oral soft tissues), and further improvements in this aspect of endosseous implants would therefore be desirable.

Apart from their appearance, current implant/abutment designs also do not satisfactorily accommodate the residual alveolar ridge anatomy that is typical of an edentulous implant site. In particular, the prior art does not allow for maintenance of the peri-implant bone height, post implant placement, which clinically is typically found to be more coronal on the palatal aspect of the edentulous alveolar ridge, while the facial ridge height is more apical, all of which is due to uneven alveolar bone healing/resorption patterns. These patterns of bone loss can be influenced by the placement and subsequent loading of an implant in the area, and while some prior art designs do accommodate the alveolar architecture on the facial aspect, they fail to accommodate the more residual ridge anatomy on the palatal aspect, which is more coronal, thus resulting an undesirable loss of peri-implant bone on this aspect of the alveolar ridge.

Accordingly, it is a general and principal object of the present invention to provide an improved dental restoration system, particularly the implant fixture and/or abutment components thereof, such that many of the foregoing problems are eliminated.

In addition, it is a specific object of the present invention to reduce and/or eliminate the non-aesthetic dark and/or shadowy appearance of existing dental restoration systems, while providing sufficient strength to withstand the forces of mastication and allowing a high degree of osseointegration, and at the same time establishing a tissue-friendly peri-implant environment and improving peri-implant health.

It is another specific object of the present invention to provide a dental restoration system which better accommodates the residual alveolar ridge anatomy that is typical of an edentulous implant site.

### SUMMARY OF THE INVENTION

The objects and advantages of the present invention are achieved by providing a dental implant fixture and abutment system fabricated generally of dental grade titanium alloys, certain portions of which are coated with a bio-compatible material that is capable of camouflaging the unsightly dark and/or shadowy appearance produced by the use of such alloys. The bio-compatible coating material may be applied either to at least a portion of the implant fixture or to at least a portion of the abutment, but preferably it is applied to at least a portion of both of these elements, and most preferably it is applied only to the coronal regions of both of these elements, and is contoured on the implant fixture such that it extends further apically on the facial aspect than on the palatal aspect, allowing for subgingival positioning of the coating on the facial aspect upon placement of the implant. In the preferred embodiments, the bio-compatible coating material comprises gold, which can be applied using a variety of methods, and which provides a highly polished surface that resists plaque adherence and sustains optimal peri-implant health.

The invention encompasses both one-stage and two-stage dental implants having the foregoing characteristics, and extends to dental restoration systems in which a prosthetic tooth device or crown is combined with a one-stage or two-stage dental implant having such characteristics. Optionally, the implant fixture is shaped such that, upon placement of the implant, the transgingival portions of the implant fixture are more coronal on the palatal aspect and more apical on the facial aspect, accommodating the differences in the residual alveolar ridge morphology and allowing for maintenance of peri-implant bone height post implant placement.

### BRIEF DESCRIPTION OF THE DRAWINGS

These and other aspects, features, objects and advantages of the present invention will become more apparent from the following detailed description of the presently most preferred embodiments thereof (which are given for the purposes of disclosure), when read in conjunction with the accompanying drawings (which form a part of the specification, but which are not to be considered limiting in its scope), wherein:

FIG. 1 is a front elevational view, partially broken away, showing the environment in which the dental implant fixture and abutment system of the present invention is most preferably used, and featuring two illustrative instances thereof;

FIG. 2 is an enlarged cross-sectional view, taken substantially along the lines 2-2 of FIG. 1, and partially broken away;

FIG. 3 is a cross-sectional view, taken substantially along the lines 3-3 of FIG. 2;

FIG. 4 is an exploded perspective view illustrating the elements of a two-stage dental implant fixture and abutment system in accordance with a preferred embodiment of the present invention, and also showing a tool with which the implant fixture may be secured;

FIG. 5 is an enlarged front elevational view of the dental implant fixture and abutment system of the present invention;

FIG. 6 is a side elevational view of the apparatus of FIG. 5;

FIG. 7 is a rear elevational view of the apparatus of FIG. 5;

FIG. 8 is an elevational view of an abutment post fabricated in accordance with the present invention; and

FIG. 9 is a greatly enlarged microscopic cross-sectional view, taken substantially along the lines 9-9 of FIG. 5.

### DETAILED DESCRIPTION OF THE PREFERRED EMBODIMENTS

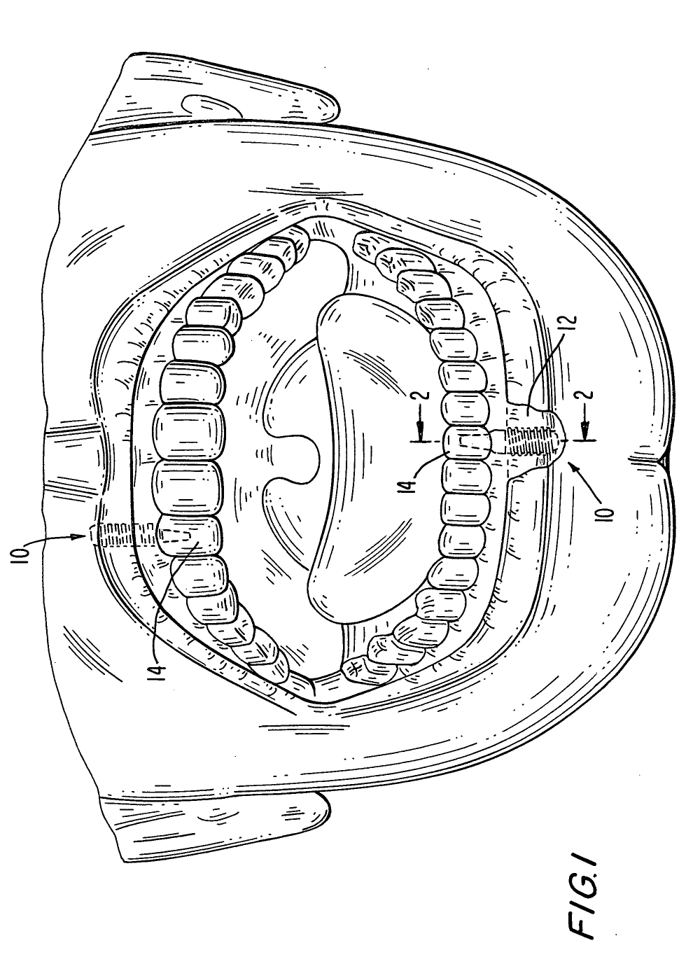

Referring now to the drawings, FIG. 1 is an illustrative view of an adult human patient's oral cavity or mouth, showing the dentition of both the upper and lower dental arches, and in which an apparatus comprising an aesthetic dental implant fixture and abutment system according to the present invention is generally designated 10. Two instances of apparatus 10 are shown in phantom in FIG. 1, both of which located in the anterior region of the mouth and are already fully inserted into the maxillary bone 12, and both of which are shown already connected to and supporting an associated prosthetic dental restoration (“prosthesis”) 14, shaped and sized to mimic incisor teeth.

Although the apparatus of the present invention may also be used in the posterior portions of the mouth, in conjunction with a patient's mandibular bone, it will nevertheless be understood by those skilled in the art that the invention will find its primary use in the anterior portions of the mouth, where the interior of the oral cavity and the dentition are ordinarily more visible to others, especially when the subject smiles, speaks or eats, and where the primary motivation therefore exists for reducing and/or eliminating the non-aesthetic dark root and crown appearance caused by the use of existing dental restoration systems.

It will also be understood by those skilled in the art that although the apparatus of the present invention is disclosed herein primarily for use in a two-stage dental implant procedure, wherein the implant fixture is first inserted into and then allowed to become integrated with the bone, followed after healing with the attachment of an abutment post, the inventive aspects may also be provided in a one-stage design, in which either the abutment post is pre-attached to the implant fixture prior to the time of surgical insertion, or the implant body is of one-piece construction with the coronal end of the implant body extending through the gingival tissue and serving as a built-in abutment post for attachment of the prosthesis.

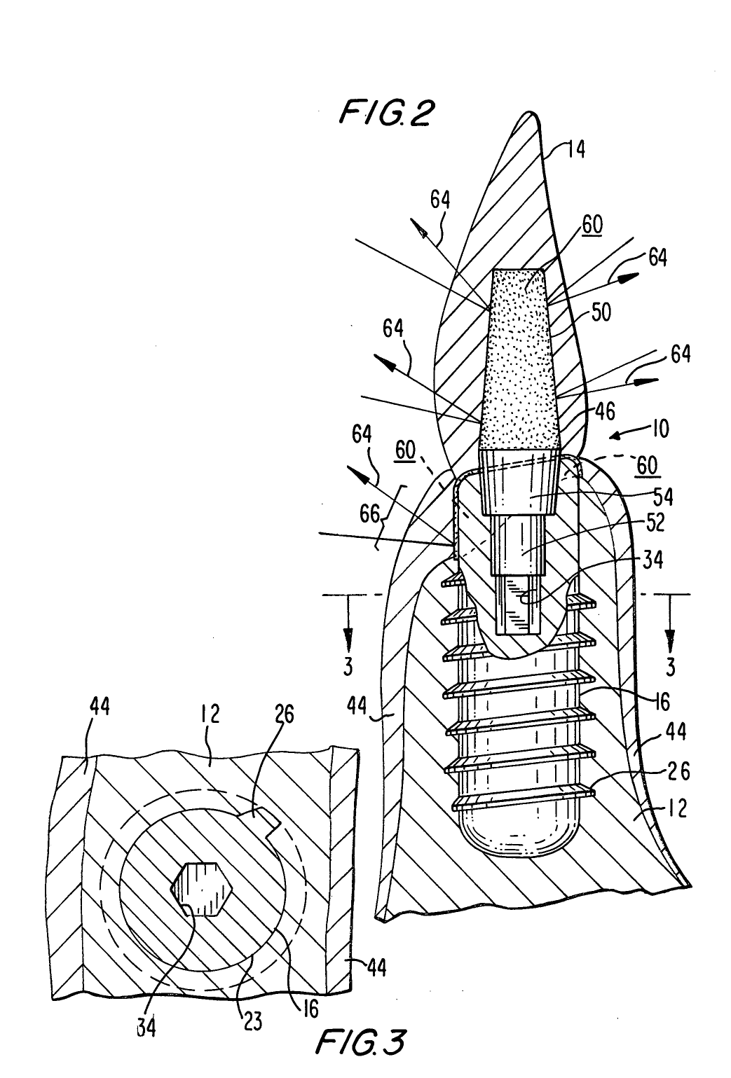

Referring now to FIGS. 2-4 in addition to the aforementioned FIG. 1, the apparatus 10 of the present invention comprises an implant fixture 16, fabricated of a typical dental grade titanium alloy and having an exterior surface 18, a gingival end 20, a distal end 22, a shank region 23, and a collar region 24 disposed adjacent the gingival end 20. Fixture 16 has a longitudinal structure which is preferably generally cylindrical in shape, and is adapted for implantation and anchoring in a patient's maxillary bone 12, preferably by means of external screw threads 26 carried on the exterior surface of shank region 23 for engagement with bone 12, although it is to be understood that any other suitable bone engagement means known in the art may be used, so long as fixture 16 is securely anchored.

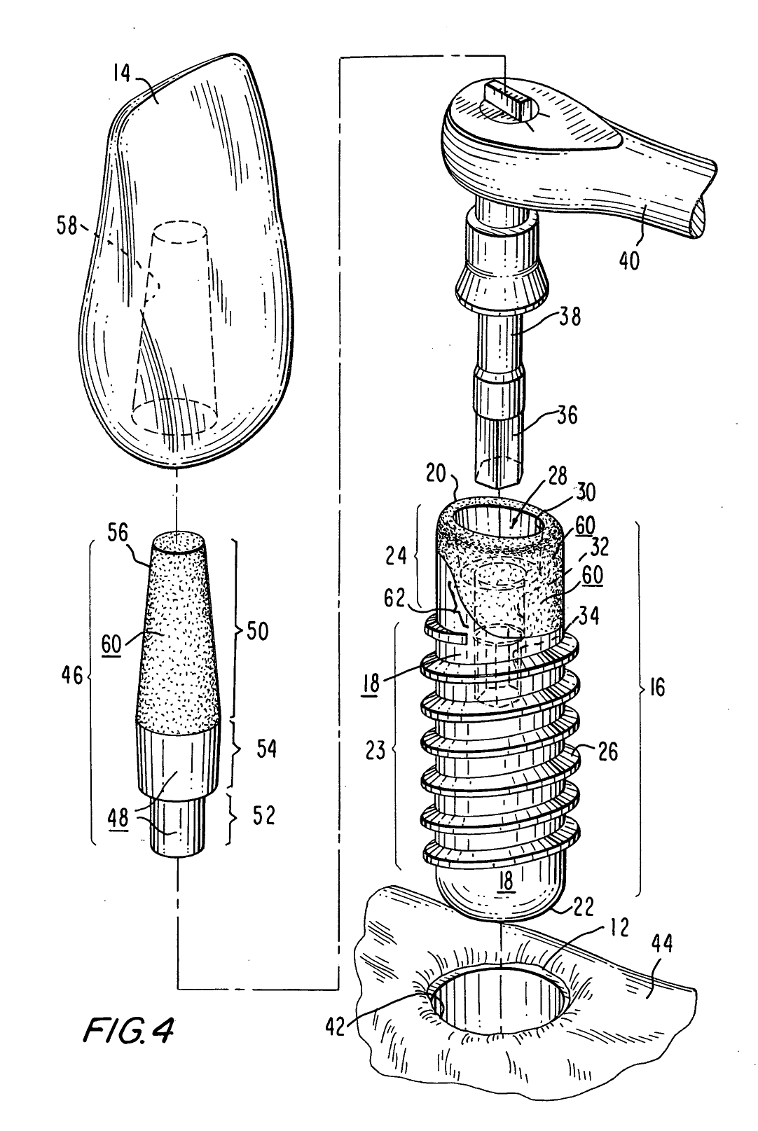

In the preferred embodiment, and as shown most clearly in FIGS. 2 and 4, implant fixture 16 is provided at its gingival end 20 with a coaxial internal cavity 28, which communicates with the atmosphere and extends longitudinally within collar region 24 towards distal end 22, terminating within shank region 23. Cavity 28 comprises a series of successively narrower recesses 30, 32 and 34, the first recess 30 being in communication with the second recess 32, which in turn is in communication with the third recess 34. Recess 30 is generally cylindrical but is tapered, having a slightly larger diameter adjacent gingival end 20 than adjacent recess 32, while recess 32 is substantially cylindrical and of reduced diameter as compared with recess 30. The third recess 34 is of further reduced diameter, as compared with recesses 30 and 32, and is substantially hexagonal in cross-section, as shown best in FIG. 3, in order to be engaged by the hexagonal bit 36 carried on an extension 38 of a conventional torque wrench 40 (the head portion of which is shown in FIG. 4). As is well known in the art, torque wrench 50 may be used to insert implant fixture 16 into, and to anchor it within, a bore 42 that is pre-drilled through the patient's gingival tissues 44 and into the maxillary bone 12, the inner surface of bore 42 preferably including pre-formed internal screw threads (not shown) that match external screw threads 26 carried on implant fixture 16.

Apparatus 10 further comprises an abutment post 46 fabricated of a typical dental grade titanium alloy and having an exterior surface 48, a coronal region 50, an apical region 52 and a neck region 54 disposed between coronal region 50 and apical region 52. Abutment post 46 has a longitudinal structure which is preferably generally cylindrical in shape, and is adapted for coaxial mating engagement with prosthesis 14 coronally and with implant fixture 16 apically. Most preferably, apical region 52 of abutment post 46 is substantially cylindrical, while neck region 54 is generally cylindrical but tapers apically, having a slightly larger diameter adjacent coronal region 50 than adjacent apical region 52, such that when apical region 52 of abutment post 46 is disposed abutting the gingival end 20 of implant fixture 16, neck region 54 may be received in recess 30 of implant fixture 16 in a friction fit, while apical region 52 is received in recess 32, also in a friction fit. Also most preferably, coronal region 50 of abutment post 46 comprises a longitudinally projecting head 56 for mounting prosthesis 14 on abutment post 46. Head 56 is generally cylindrical but tapers coronally, having a slightly larger diameter adjacent neck region 54 to enable it to be received in a friction fit in a correspondingly tapered opening 58 which is disposed within the base of, and extends internally within, prosthesis 14.

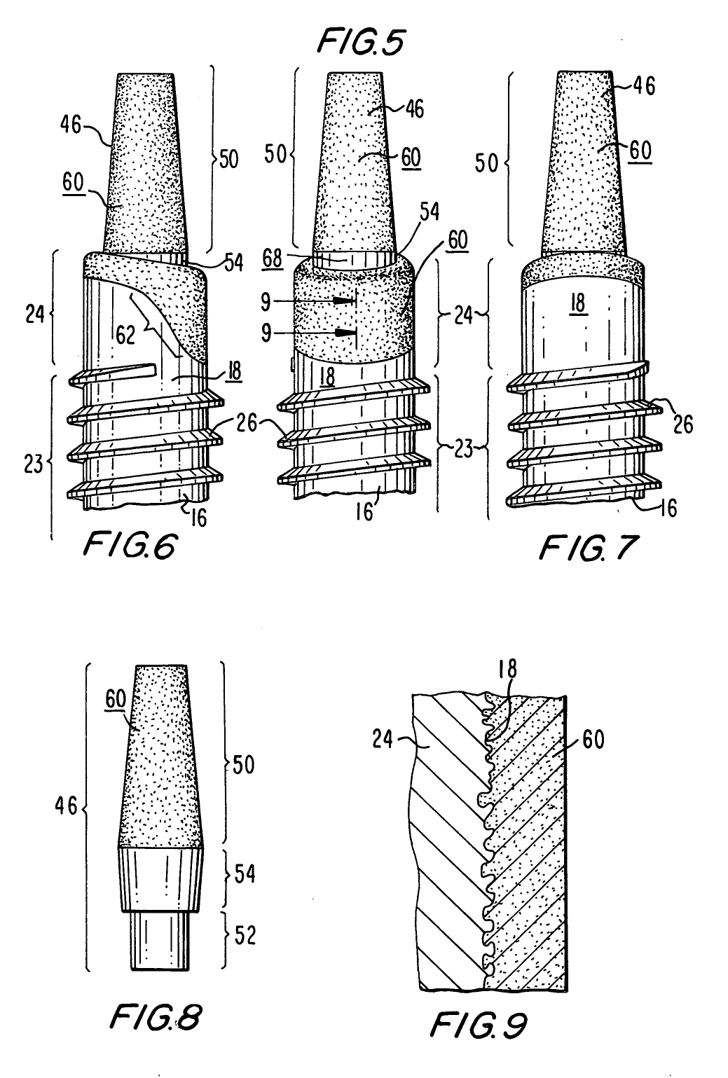

In accordance with the invention, apparatus 10 further comprises a coating of a bio-compatible material extending over at least a portion of implant fixture 16, or over at least a portion of abutment post 46, but preferably extending over at least a portion of both implant fixture 16 and abutment post 46, and more preferably extending only over the coronal regions of both of these elements. Even more preferably, and referring now to FIGS. 5-9 in addition to the aforementioned FIGS. 1-4, the coating, which is designated by the numeral 60, extends over and substantially covers the exterior surface 48 of the coronal region 50 of abutment post 46, as well as at least a portion of the exterior surface 18 of the collar region 24 of implant fixture 16. Most preferably, the coating 60 circumscribes at least the head 56 of abutment post 46, i.e., the portion of abutment post 46 that is received within opening 58 of prosthesis 14, and the coating 60 circumscribes the collar region 24 of implant fixture 16, as shown in FIGS. 5-7, but is specifically and most preferably applied to implant fixture 16 such that coating 60 has a contour, which is designated generally by the numeral 62, allowing it to extend further longitudinally on one side of implant fixture 16 than the other, as shown most clearly in FIGS. 4 and 6. The contour 62 is oriented such that when implant fixture 16 is implanted and fully anchored in the maxillary bone 12, the coating 60 has a coating length defined between gingival end 20 and distal end 22 that is greatest on the facial aspect and that is least on the palatal aspect, i.e., the coating extends further apically on the facial aspect than on the palatal aspect of fixture 16, as shown most clearly in FIG. 2.

In the preferred embodiments, the coating 60 comprises a layer of either pure gold or an alloy of gold. Clinical observations by the inventors have shown that gold produces superior aesthetics while having excellent bio-compatibility, resulting in significantly better post-implant gingival health adjacent gold surfaces in dental restorations; the latter may be due to certain innate properties of gold and/or to the very smooth surface topography that can be achieved when the gold is highly polished, which may discourage plaque adherence and retention, thereby producing a more tissue-friendly hygienic surface.

The pure gold or gold alloy (both hereinafter referred to as “gold”) is preferably applied to the titanium surfaces of the implant fixture 16 and/or the abutment post 46 after those surfaces have been appropriately roughened to produce channels of sufficient width and depth, as shown in FIG. 9, to achieve the asymmetrical interface that is depicted in FIG. 9 and resulting in a mechanical interlock mechanism that maximizes the adherence of the gold. The roughening can be accomplished by any method known in the art, such as by grit blasting or acid etching, followed by direct application of gold powder and melting, although it is also possible to apply the gold via sputtering or electroplating, or via any other method which would allow for mass production. It has been found that the most favorable result is achieved using grit blasting, with particles in the 50-150 micron range (aluminum oxide particles of about 50 micron size for use in such grit blasting are available commercially from Parkell of Farmingdale, N.Y.), followed by application of gold powder (available commercially under the name Aurofilm 2000 from Metalor Corporation Meataux Precieux SA of Neuchatel, Switzerland), and melting in a conventional dental ceramic oven at 1700° F. under no vacuum and with no holding time, resulting in a gold coating which is approximately 35 to 50 microns thick and which may then be highly polished in a known manner to achieve a gold chroma.

As shown by the arrows 64 in FIG. 2, the coating 60, when made of gold, ensures that incident light is reflected from the translucent peri-implant tissues, i.e., from both the prosthesis 14 and the gingival tissue 44, particularly the facial segment of the latter which surrounds collar region 24 and is designated by the numeral 66, with an aesthetically pleasing light gold chroma, producing a highly bio-mimetic result.

In accordance with the invention, implant fixture 16 may optionally be formed asymmetrically, specifically with a lateral slope at gingival end 20, such that the longitudinal distance from gingival end 20 to distal end 22 is greater on one side of implant fixture 16 than the other, as shown most clearly in FIGS. 2 and 6. The slope is oriented such that when implant fixture 16 is implanted and fully anchored in the maxillary bone 12, implant fixture 16 has a fixture length defined between gingival end 20 and distal end 22 that is greatest on the palatal aspect and that is least on the facial aspect, i.e., the gingival end 20 is lower on the facial aspect and higher on the palatal aspect of fixture 16, such that the transgingival portions of implant fixture 16, particularly collar region 24, are more coronal on the palatal aspect and more apical on the facial aspect, accommodating the differences in the residual alveolar ridge morphology typical of an edentulous implant site, and allowing for maintenance of peri-implant bone height post implant placement, as shown most clearly in FIG. 2.

If implant fixture 16 is formed asymmetrically in accordance with the option described above, then as shown most clearly in FIG. 5, a portion of the exterior surface 48 of abutment post 46, to which the gold coating 60 does not extend (that portion is designated by the numeral 68 in FIG. 5), will be visible prior to the engagement of the prosthesis 14 with abutment post 46. Consequently, after such engagement, and after placement of the implant, the innate gray-black chroma of the titanium alloy from which portion 68 is fabricated will detract from the gold chroma conferred by the presence of the gold coating on the other portions of the abutment post 46 and on the implant fixture 16, and cause a reduction in the bio-mimetic effect. Therefore, in the event that the asymmetric design is used, it will be beneficial to extend the gold coating 60 apically on abutment post 46 by a small distance, to insure that all of the “visible” titanium alloy is coated.

The present invention may be utilized in a two-stage implant design, wherein the implant fixture 16 and the abutment post 46 are provided separately and are introduced into the mouth in two separate steps (a separate abutment post 46 in accordance with the invention is shown best in FIG. 8, a microscopic cross-section of which would appear similar to FIG. 9). However, as mentioned previously, the invention may also be employed to advantage in a one-stage implant design, wherein either the abutment post is pre-attached to the implant fixture prior to the time of surgical insertion, or the implant fixture and the abutment post are formed integrally, i.e., the implant body is of one-piece construction, with a distal end, an apical region adjacent the distal end which is adapted for anchoring in the patient's jawbone (maxillary or mandibular), a proximal end, and a coronal region adjacent the proximal end which extends through the gingival tissue and comprises a shoulder and a longitudinal projection extending from the shoulder and serving as a built-in abutment post for attachment of the prosthesis. The principles of the present invention may be utilized in such a one-stage dental implant by applying the coating, in the manner described hereinabove, to the exterior surface of the projection and to the exterior surface of an intermediate region formed apically of the shoulder and coronally of the apical region. The views of FIGS. 5-7 are equally applicable to such a one-piece construction as they are to a more conventional two-piece construction.

While there has been described what are at present considered to be the preferred embodiments of the present invention, it will be apparent to those skilled in the art that the embodiments described herein are by way of illustration and not of limitation, and that various changes and modifications may be made therein without departing from the true spirit and scope of the present invention, as set forth in the appended claims.

1. A two-stage dental implant for mounting and supporting a dental prosthesis, the implant comprising:
an implant fixture adapted for anchoring within a patient's mandibular or maxillary bone, said implant fixture formed from titanium or titanium alloys having a grayish or metallic color,
an abutment post adapted for engaging said implant fixture and for mounting said prosthesis, said abutment post formed from titanium or titanium alloys having a grayish or metallic color, and
a coating of a material capable of camouflaging said grayish or metallic color, said coating extending over and substantially covering at least a portion of said dental implant.

2. The implant of claim 1 wherein said coating extends over at least a portion of said implant fixture.

3. The implant of claim 1 wherein said coating extends over at least a portion of said abutment post.

4. The implant of claim 3 wherein said coating extends over at least a portion of said implant fixture.

5. The implant of any one of claims 1-4 wherein said coating comprises gold.

6. A two-stage dental implant for mounting and supporting a dental prosthesis, the implant comprising:
an implant fixture adapted for anchoring within a patient's mandibular or maxillary bone,
an abutment post adapted for engaging said implant fixture and for mounting said prosthesis, and
a gold coating extending over and substantially covering at least a portion of said dental implant.

7. The implant of claim 6 wherein said coating extends over at least a portion of said implant fixture.

8. The implant of claim 6 wherein said coating extends over at least a portion of said abutment post.

9. The implant of claim 8 wherein said coating extends over at least a portion of said implant fixture.

10. The implant of any one of claims 6-9, wherein said implant fixture and said abutment post are formed from titanium or titanium alloys having a grayish or metallic color, and wherein said gold coating camouflages said grayish or metallic color.

11. A one-stage dental implant for mounting and supporting a dental prosthesis, the dental implant formed from titanium or titanium alloys having a grayish or metallic color and adapted for anchoring within a patient's mandibular or maxillary bone and for supporting said prosthesis, said dental implant comprising a coating of a material capable of camouflaging said grayish or metallic color, said coating extending over and substantially covering at least a portion of said dental implant.

12. The implant of claim 11 wherein said coating comprises gold.

13. A one-stage dental implant for mounting and supporting a dental prosthesis, the dental implant adapted for anchoring within a patient's mandibular or maxillary bone and for supporting said prosthesis, said dental implant comprising a gold coating extending over and substantially covering at least a portion of said dental implant.

14. The implant of claim 13, wherein said implant is formed from titanium or titanium alloys having a grayish or metallic color, and wherein said gold coating camouflages said grayish or metallic color.

15. A dental restoration system comprising
a dental prosthesis,
an implant fixture adapted for anchoring within a patient's mandibular or maxillary bone, said implant fixture formed from titanium or titanium alloys having a grayish or metallic color,
an abutment post adapted for engaging said implant fixture and for mounting said prosthesis, said abutment post formed from titanium or titanium alloys having a grayish or metallic color, and
a coating of a material capable of camouflaging said grayish or metallic color, said coating extending over and substantially covering at least a portion of said implant fixture or at least a portion of said abutment post.

16. The dental restoration system of claim 15 wherein said coating extends over at least a portion of said implant fixture.

17. The dental restoration system of claim 15 wherein said coating extends over at least a portion of said abutment post.

18. The dental restoration system of claim 17 wherein said coating extends over at least a portion of said implant fixture.

19. The dental restoration system of any one of claims 15-18 wherein said coating comprises gold.

20. A dental restoration system comprising
a dental prosthesis,
an implant fixture adapted for anchoring within a patient's mandibular or maxillary bone,
an abutment post adapted for engaging said implant fixture and for mounting said prosthesis, and
a gold coating extending over and substantially covering at least a portion of said implant fixture or at least a portion of said abutment post.

21. The dental restoration system of claim 20 wherein said coating extends over at least a portion of said implant fixture.

22. The dental restoration system of claim 20 wherein said coating extends over at least a portion of said abutment post.

23. The dental restoration system of claim 22 wherein said coating extends over at least a portion of said implant fixture.

24. The dental restoration system of any one of claims 20-23, wherein said implant fixture and said abutment post are formed from titanium or titanium alloys having a grayish or metallic color, and wherein said gold coating camouflages said grayish or metallic color.

25. A dental restoration system comprising
a dental prosthesis, and
a one-stage dental implant for mounting and supporting a dental prosthesis, the dental implant formed from titanium or titanium alloys having a grayish or metallic color and adapted for anchoring within a patient's mandibular or maxillary bone and for supporting said prosthesis, said dental implant comprising a coating of a material capable of camouflaging said grayish or metallic color, said coating extending over and substantially covering at least a portion of said dental implant.

26. The dental restoration system of claim 25 wherein said coating comprises gold.

27. A dental restoration system comprising
a dental prosthesis, and
a one-stage dental implant for mounting and supporting a dental prosthesis, the dental implant adapted for anchoring within a patient's mandibular or maxillary bone and for supporting said prosthesis, said dental implant comprising a gold coating extending over and substantially covering at least a portion of said dental implant.

28. The dental restoration system of claim 27, wherein said implant is formed from titanium or titanium alloys having a grayish or metallic color, and wherein said gold coating camouflages said grayish or metallic color.

29. A two-stage dental implant for mounting and supporting a dental prosthesis, the implant having a longitudinal axis and comprising:
an implant fixture for anchoring within a patient's mandibular or maxillary bone, said implant fixture formed from titanium or titanium alloys having a grayish or metallic color, said implant fixture comprising an exterior surface, a gingival end, a distal end and a collar region disposed therebetween and adjacent said gingival end,
an abutment post disposed coaxially with said implant fixture, said abutment post formed from titanium or titanium alloys having a grayish or metallic color, said abutment post comprising an exterior surface, a coronal region, an apical region and a neck region disposed therebetween, said coronal region comprising a longitudinally projecting head for mounting said prosthesis, and said apical region being adapted to engage said implant fixture and to abut against the gingival end thereof, and
a coating of a material capable of camouflaging said grayish or metallic color, said coating extending over and substantially covering the exterior surface of the coronal region of said abutment post and at least a portion of the exterior surface of the collar region of said implant fixture.

30. The implant of claim 29 wherein said implant fixture has a palatal aspect and a facial aspect when anchored in said bone, wherein said coating on said collar region extends from said gingival end towards said distal end and has a coating length defined between said ends, and wherein said coating on said collar region is contoured such that said coating length is greatest on the generally facial aspect and least on the generally palatal aspect.

31. The implant of claim 30 wherein said coating comprises gold.

32. The implant of claim 31 wherein said implant fixture has a fixture length defined between said gingival end and said distal end, and wherein said gingival end is sloped such that said fixture length is greatest on the generally palatal aspect and least on the generally facial aspect.

33. The implant of claim 32 wherein said implant fixture further comprises a shank region adjacent to said collar region and extending therefrom towards said distal end, the exterior surface in said shank region comprising a bone engaging surface, and wherein said collar region is disposed when said implant fixture is anchored in said bone such that the collar region extends through and ends beyond the gingival tissues surrounding said implant.

34. The implant of claim 33 wherein said bone engaging surface comprises an external thread disposed on the exterior surface in said shank region.

35. The implant of claim 33 wherein said apical region of said abutment post comprises an outer longitudinal male projection, and wherein said gingival end of said implant fixture comprises a longitudinal recess disposed axially and defining an inner female cavity for mating engagement with said projection.

36. A two-stage dental implant for mounting and supporting a dental prosthesis, the implant having a longitudinal axis and comprising:
an implant fixture adapted for anchoring within a patient's mandibular or maxillary bone, said implant fixture comprising an exterior surface, a gingival end, a distal end and a collar region disposed therebetween and adjacent said gingival end,
an abutment post disposed coaxially with said implant fixture, said abutment post comprising an exterior surface, a coronal region, an apical region and a neck region disposed therebetween, said coronal region comprising a longitudinally projecting head for mounting said prosthesis, and said apical region being adapted to engage said implant fixture and to abut against the gingival end thereof, and
a gold coating extending over and substantially covering the exterior surface of the coronal region of said abutment post and at least a portion of the exterior surface of the collar region of said implant fixture.

37. The implant of claim 36 wherein said implant fixture has a palatal aspect and a facial aspect when anchored in said bone, wherein said gold coating on the exterior surface of said collar region extends from said gingival end towards said distal end and has a coating length defined between said ends, and wherein said gold coating on said collar region is contoured such that said coating length is greatest on the generally facial aspect and least on the generally palatal aspect.

38. The implant of claim 37 wherein said implant fixture has a fixture length defined between said gingival end and said distal end, and wherein said gingival end is sloped such that said fixture length is greatest on the generally palatal aspect and least on the generally facial aspect.

39. The implant of claim 38 wherein said implant fixture further comprises a shank region adjacent to said collar region and extending therefrom towards said distal end, the exterior surface in said shank region comprising a bone engaging surface, and wherein said collar region is disposed when said implant fixture is anchored in said bone such that the collar region extends through and ends beyond the gingival tissues surrounding said implant.

40. The implant of claim 39 wherein said bone engaging surface comprises an external thread disposed on the exterior surface in said shank region.

41. The implant of claim 40 wherein said apical region of said abutment post comprises an outer longitudinal male projection, and wherein said gingival end of said implant fixture comprises a longitudinal recess disposed axially and defining an inner female cavity for mating engagement with said projection.

42. The implant of claim 38 wherein said implant fixture and said abutment post are formed from titanium or titanium alloys having a grayish or metallic color, and wherein said gold coating camouflages said grayish or metallic color.

43. A one-stage dental implant for mounting and supporting a dental prosthesis, the implant formed from titanium or titanium alloys having a grayish or metallic color and comprising a generally longitudinal body having an exterior surface, a proximal end, a distal end, an apical region disposed adjacent said distal end and adapted for anchoring said implant within a patient's mandibular or maxillary bone, and a coronal region disposed adjacent said proximal end and comprising a projection adapted to receive and to engage said prosthesis, said implant further comprising a shoulder disposed distal to said coronal region and adjacent to said projection, an intermediate region disposed distal to said shoulder, and a coating of a material capable of camouflaging said grayish or metallic color, said coating substantially covering the exterior surface of said projection and at least a portion of the exterior surface of said intermediate region.

44. The implant of claim 43 wherein said implant has a palatal aspect and a facial aspect when anchored in said bone, wherein said coating on the exterior surface of said intermediate region extends from said shoulder distally towards said apical region and has a coating length defined between said shoulder and said distal end, and wherein said coating on said intermediate region is contoured such that said coating length is greatest on the generally facial aspect and least on the generally palatal aspect.

45. The implant of claim 44 wherein said coating comprises gold.

46. The implant of claim 45 wherein said implant has an intermediate length defined between said shoulder and said distal end, and wherein said shoulder is sloped such that said intermediate length is greatest on the generally palatal aspect and least on the generally facial aspect.

47. The implant of claim 46 wherein the exterior surface in said apical region comprises a bone engaging surface, and wherein said shoulder and said intermediate region are disposed transgingivally when said implant is anchored in said bone.

48. The implant of claim 47 wherein said bone engaging surface comprises an external thread disposed on the exterior surface in said apical region.

49. A one-stage dental implant for mounting and supporting a dental prosthesis, the implant comprising a generally longitudinal body having an exterior surface, a proximal end, a distal end, an apical region disposed adjacent said distal end and adapted for anchoring said implant within a patient's mandibular or maxillary bone, and a coronal region disposed adjacent said proximal end and comprising a longitudinal projection for mounting said prosthesis, said implant further comprising a shoulder disposed distal to said coronal region and adjacent to said projection, an intermediate region disposed distal to said shoulder, and a gold coating extending over and substantially covering the exterior surface of said projection and at least a portion of the exterior surface of said intermediate region.

50. The implant of claim 49 wherein said implant has a palatal aspect and a facial aspect when anchored in said bone, wherein said gold coating on the exterior surface of said intermediate region extends from said shoulder distally towards said apical region and has a coating length defined between said shoulder and said distal end, and wherein said gold coating on said intermediate region is contoured such that said coating length is greatest on the generally facial aspect and least on the generally palatal aspect.

51. The implant of claim 50 wherein said implant has an intermediate length defined between said shoulder and said distal end, and wherein said shoulder is sloped such that said intermediate length is greatest on the generally palatal aspect and least on the generally facial aspect.

52. The implant of claim 51 wherein the exterior surface in said apical region comprises a bone engaging surface, and wherein said shoulder and said intermediate region are disposed transgingivally when said implant is anchored in said bone.

53. The implant of claim 52 wherein said bone engaging surface comprises an external thread disposed on the exterior surface in said apical region.

54. The implant of claim 53 wherein said body is formed from titanium or titanium alloys having a grayish or metallic color, and wherein said gold coating camouflages said grayish or metallic color.

55. A dental restoration system having a longitudinal axis and comprising
a dental prosthesis,
an implant fixture for anchoring within a patient's mandibular or maxillary bone, said implant fixture formed from titanium or titanium alloys having a grayish or metallic color, said implant fixture comprising an exterior surface, a gingival end, a distal end and a collar region disposed therebetween and adjacent said gingival end,
an abutment post disposed coaxially with said implant fixture, said abutment post formed from titanium or titanium alloys having a grayish or metallic color, said abutment post comprising an exterior surface, a coronal region, an apical region and a neck region disposed therebetween, said coronal region comprising a longitudinally projecting head for mounting said prosthesis, and said apical region being adapted to engage said implant fixture and to abut against the gingival end thereof, and
a coating of a material capable of camouflaging said grayish or metallic color, said coating extending over and substantially covering the exterior surface of the coronal region of said abutment post and at least a portion of the exterior surface of the collar region of said implant fixture.

56. The dental restoration system of claim 55 wherein said coating comprises gold.

57. A dental restoration system having a longitudinal axis and comprising
a dental prosthesis,
an implant fixture adapted for anchoring within a patient's mandibular or maxillary bone, said implant fixture comprising an exterior surface, a gingival end, a distal end and a collar region disposed therebetween and adjacent said gingival end, an abutment post disposed coaxially with said implant fixture, said abutment post comprising an exterior surface, a coronal region, an apical region and a neck region disposed therebetween, said coronal region comprising a longitudinally projecting head for mounting said prosthesis, and said apical region being adapted to engage said implant fixture and to abut against the gingival end thereof, and
a gold coating extending over and substantially covering the exterior surface of the coronal region of said abutment post and at least a portion of the exterior surface of the collar region of said implant fixture.

58. The implant of claim 57 wherein said implant fixture and said abutment post are formed from titanium or titanium alloys having a grayish or metallic color, and wherein said gold coating camouflages said grayish or metallic color.

59. A dental restoration system comprising
a dental prosthesis, and
a one-stage dental implant for mounting and supporting said prosthesis, the implant formed from titanium or titanium alloys having a grayish or metallic color and comprising a generally longitudinal body having an exterior surface, a proximal end, a distal end, an apical region disposed adjacent said distal end and adapted for anchoring said implant within a patient's mandibular or maxillary bone, and a coronal region disposed adjacent said proximal end and comprising a projection adapted to receive and to engage said prosthesis, said implant further comprising a shoulder disposed distal to said coronal region and adjacent to said projection, an intermediate region disposed distal to said shoulder, and a coating of a material capable of camouflaging said grayish or metallic color, said coating substantially covering the exterior surface of said projection and at least a portion of the exterior surface of said intermediate region.

60. The dental restoration system of claim 59 wherein said coating comprises gold.

61. A dental restoration system comprising
a dental prosthesis, and
a one-stage dental implant for mounting and supporting said prosthesis, the implant comprising a generally longitudinal body having an exterior surface, a proximal end, a distal end, an apical region disposed adjacent said distal end and adapted for anchoring said implant within a patient's mandibular or maxillary bone, and a coronal region disposed adjacent said proximal end and comprising a longitudinal projection for mounting said prosthesis, said implant further comprising a shoulder disposed distal to said coronal region and adjacent to said projection, an intermediate region disposed distal to said shoulder, and a gold coating extending over and substantially covering the exterior surface of said projection and at least a portion of the exterior surface of said intermediate region.

62. The implant of claim 61 wherein said implant body and said abutment post are formed from titanium or titanium alloys having a grayish or metallic color, and wherein said gold coating camouflages said grayish or metallic color.
